(19) United States
(12) Patent Application Publication
(10) Pub. No.: US 2025/0198867 A1
(43) Pub. Date: Jun. 19, 2025

(54) MEMBRANE SENSOR FOR COMPENSATION OF AN ACCELERATION AND CORRESPONDING OPERATING METHOD

(71) Applicant: Robert Bosch GmbH, Stuttgart (DE)

(72) Inventor: Johannes Classen, Reutlingen (DE)

(21) Appl. No.: 18/867,168

(22) PCT Filed: May 15, 2023
(86) PCT No.: PCT/EP2023/062946

§ 371 Date: Feb. 10, 2025

(30) Foreign Application Priority Data
Jun. 1, 2022 (DE) 10 2022 205 601.9

(51) Int. Cl. G01L 9/00; G01L 19/06

(52) U.S. Cl. CPC G01L 9/0072; G01L 19/0627

(57) ABSTRACT

A micromechanical membrane sensor, and a method which is suitable for determining a sensor value and/or a sensor variable of the membrane sensor. The sensor value of the membrane sensor is determined such that the weight force or another acceleration onto the membrane is largely compensated.

### FIELD

The present invention relates to a membrane sensor in which an applied acceleration or weight force on the membrane is taken into account when determining a sensor value, and to a corresponding operating method.

### BACKGROUND INFORMATION

Micromechanical membrane sensors are often exposed directly to the medium whose physical and/or chemical properties are to be measured. To protect the membrane, the membrane or at least the sensitive sensor structures located on the membrane can be protected with a gel in order to prevent corrosion and/or deposition of unwanted adsorbates. However, the use of a protective gel on the membrane surface changes the behavior of the membrane, in particular in the case of a pressure sensor, so that a change in the sensor variables to be detected or in the sensor value to be determined with the membrane sensor can occur.

Especially in the case of pressure sensors, coating the membrane with a protective gel can lead to a significant additional weight force on the membrane and thus to an orientation-dependent g-sensitivity or, in general, an acceleration sensitivity in the measured value detection. As the accuracy of the detected sensor values increases, the mass of the membrane or the total mass of the membrane and (gel) coverage becomes a greater inaccuracy factor in the determination of the sensor value.

The influence of the orientation-dependent acceleration due to gravity onto the membrane can be computationally calculated if, in addition to the membrane sensor, the signal from an acceleration sensor is also present, as is the case in most smartphones. In order to make this computational compensation possible, an adjustment is necessary during production. In addition, the evaluation unit for the membrane sensor must be operated in addition to compensating for the g-sensitivity, so that additional computing capacity must be taken into account and additional energy expenditure is necessary.

### SUMMARY

The present invention related to both a micromechanical membrane sensor, more particularly a pressure sensor, and a method which is suitable for determining a sensor value and/or a sensor variable of the membrane sensor. The sensor value of the membrane sensor is determined such that the weight force or another acceleration onto the membrane is largely compensated for.

According to an example embodiment of the present invention, in addition to a first sensor element, which detects a first sensor variable representing the movement of the membrane, a second sensor element is provided, which detects a second sensor variable as a function of a weight force or acceleration. According to the present invention, the second sensor element is designed in such a way that the second sensor variable thus detected and taken into account when determining the sensor value of the sensor arrangement represents the weight force or acceleration onto the membrane. In particular, it is provided that the second sensor variable corresponds to the acceleration due to gravity or the gravitational force of the total mass of the membrane and an additional covering, or at least represents it. In addition, the construction according to the present invention can also be used to compensate for another acceleration which is not caused by the force of gravity.

An advantage of such a design or a separate detection of the influence of orientation-dependent acceleration due to gravity is that the interference effect, which can cause a falsification of the sensor measured values due to a coating on the membrane, can be compensated for without additional computing effort. In particular, a corresponding design of the second sensor element with a variable measured value detection means allows an aging effect to be compensated for, which occurs when the membrane or a gel layer located thereon is coated with adsorbates.

In one example embodiment of the present invention, it is provided that the second sensor element has a spring-mass system in which at least one first mass is connected to at least one spring element. Optionally, according to an example embodiment of the present invention, the first mass can have a movable electrode which is part of a second capacitive measured value detection means for detecting a compensation variable. Furthermore, it can be provided that the spring-mass system is attached on one side to a rigid suspension.

Particularly advantageous is an example embodiment according to the present invention in which the second sensor element has a spring-mass system, in particular in the form of a rocker structure. In particular, the spring-mass system can have, in addition to the first mass, a second mass which is also connected to the at least one spring element. In one example embodiment of the present invention, the second mass and the first mass can be connected to the same spring element, in particular at the two opposite ends or sides of the spring element. It is also possible that the second mass has a movable electrode which is part of a third capacitive measured value detection means. Optionally, the first and the second mass can have equal or substantially unequal masses. The second mass can be heavier than the first mass by a factor of 2, 5 or 10. Such an asymmetrical design of the two masses allows the second mass to move in the same direction as the membrane mass, whereby as a result of the suspension of the second mass, for example in the form of a rocker structure, the first mass moves in the opposite or counter direction. This results in a larger distance between the electrodes for the second measuring capacitance of the first mass, whereby the sensor variable thus detected can be used as a measure of the applied weight force and to compensate for the first sensor variable if the spring-mass system is dimensioned accordingly.

In a further development of the present invention, it is provided that the second mass and/or the third measured value detection means can be actively controlled or influenced, so that the stiffness of the rocker structure can be changed via this control.

According to an example embodiment of the present invention, the spring element can be arranged in the same plane as the two masses. It is also possible for the spring element to be designed as a bending spring, a torsion spring or a bending beam. Furthermore, it can be provided that the masses are arranged in the same plane as the movable electrode of the first sensor element.

According to an example embodiment of the present invention, the first sensor element can have a first capacitive measured value detection means, in which the deflection of the membrane is detected by means of a useful signal as a function of the detected capacitance or the distance between two electrodes. Optionally, the first sensor element can additionally have at least one capacitive reference measured value detection means which generates a reference signal independently of the movement of the membrane. This reference signal can be used to detect and compensate for other interfering influences on the useful signal, for example effects caused by the application of temperature.

According to an example embodiment of the present invention, the second sensor signal of the second sensor element can be used as a weight force compensation variable in addition to the useful signal. The second sensor signal can be detected separately and taken into account when evaluating the useful signal. Alternatively, however, the corresponding capacitances of the first measured value detection means, the reference measured value detection means, the second measured value detection means and the third measured value detection means can be electrically connected to one another in pairs or sequentially, so that a common sensor variable can be detected from at least two capacitive detection means without additional evaluation being necessary. It is possible, for example, to electrically connect the useful capacitance of the first sensor element and the compensation capacitance of the second sensor element by means of suitable wiring directly in the micromechanical sensor structure in particular, so that the sum of the useful and compensation capacitance is formed directly at the MEMS chip level.

Alternatively, according to an example embodiment of the present invention, the reference capacitance can also be corrected via the compensation capacitance. For this purpose, the compensation capacitance is electrically connected to the reference capacitance in such a way that both capacitances connected in parallel generate a sensor variable. Such a circuit is in particular suitable if the useful capacitance and the compensation capacitance change in the same direction as the acceleration.

According to an example embodiment of the present invention, in order to prevent resonance effects, in particular in the second sensor element, it can be provided that the second sensor element is spatially and fluidically separated from the first sensor element, for example in a separate second cavity. The second sensor element can be damped particularly advantageously by providing the corresponding second cavity with a higher internal pressure. This damping can minimize an amplitude increase in the event of coupling in the resonance frequency of the second sensor element.

Further advantages can be seen from the following description of exemplary embodiments and from the disclosure herein.

### BRIEF DESCRIPTION OF THE DRAWINGS

FIG. 1 shows a first exemplary embodiment of the present invention in which the second sensor element compensating the weight force is accommodated in an isolated or separated cavity.

FIG. 2 shows an exemplary embodiment of the present invention with a common cavity for the first and second sensor element as well as an alternative suspension of the spring-mass system.

FIG. 3 shows a further embodiment of the present invention and, in particular, its production.

FIG. 4 shows an adjustable compensation of the weight force, according to an example embodiment of the present invention.

FIG. 5 shows a block diagram of a possible evaluation and control unit for the membrane sensor according to an example embodiment of the present invention.

FIG. 6 should a method for adjusting the compensation using the second sensor element, according to an example embodiment of the present invention.

### DETAILED DESCRIPTION OF EXAMPLE EMBODIMENTS

As stated at the beginning, in membrane sensors the weight of the membrane or the total mass of the membrane and cover can result in an interference effect on the actual sensor signal. In particular, orientation-dependent deflections caused by the weight force have a detrimental effect on the quality of the recorded sensor signal. The following embodiments according to the present invention show sensor constructions which allow for compensation of the effects of such orientation-dependent deflections without the need for complex subsequent processing of the sensor signals. For this purpose, a second capacitively measuring sensor element is used in a sensor structure, in particular a micromechanical sensor construction, which generates a capacitance change as a function of an acting acceleration.

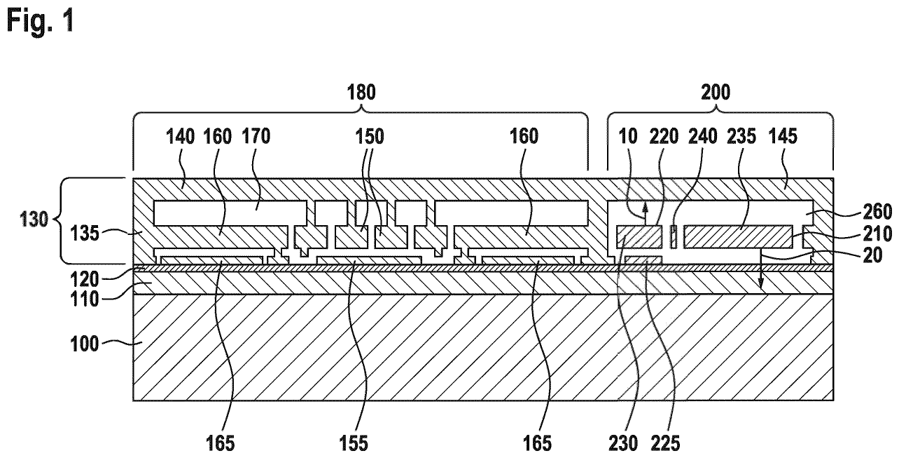

With reference to FIG. 1, a typical construction of a micromechanical membrane sensor in the form of a pressure sensor having a first sensor element 180 is described, to which, according to the present invention, a second sensor element 200 is assigned for compensating for the effect of a weight force, the acceleration due to gravity or another acceleration.

The construction of the pressure sensor consists, for example, of a substrate 100 on which an oxide layer 110 and a polysilicon layer 120 are applied. The first sensor element 180 is located on this polysilicon layer 120, which first sensor element is constructed in a common layer structure 130, for example as a sequence of a plurality of polysilicon and oxide layers. In the present construction, a functional layer 135 is provided, from which both the upper (movable) electrodes 150 of a first measured value detection means or first measuring capacitance and the upper electrodes 160 of a reference capacitance are formed. Alternatively, the individual electrodes can also be formed from different layers or structures. The corresponding lower (rigid) electrode 155 of the first measured value detection means as well as the lower electrodes 165 of the reference capacitances are applied directly to the polysilicon layer 120 and electrically separated from the substrate 100 by the oxide 110. Optionally, electrical connecting lines for contacting the lower electrodes 155 and 165 can be arranged in the polysilicon layer 120 or in the oxide layer 110, respectively. In the illustrated construction of the first sensor element 180, the upper electrodes 150 are attached directly to the membrane 180 of the membrane sensor. As a result, when pressure is applied to the membrane 140, the distance between the two electrodes 150 and 155 is changed in such a way that a measure of the deflection of the membrane 140 can be derived from the resulting change in capacitance. The electrodes 160 and 165 of the reference capacitances, on the other hand, are designed to be independent of the movement of the membrane 140, so that this reference capacitance can be used to detect interferences which affect the entire system. Typically, a gel covering (not shown in FIG. 1) is provided on the membrane 140 to protect the electrical and/or sensing structures provided on or in the membrane 140 from the medium applied to the membrane. However, this gel covering additionally covers the membrane 140 with a mass which influences the movement behavior of the membrane and has an effect due to the effect of the acceleration due to gravity g in the resting phase of the pressure sensor.

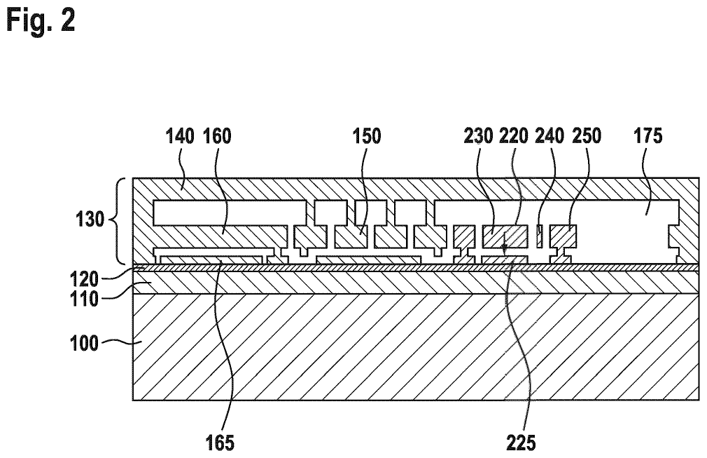

In the exemplary embodiment according to FIG. 1, the second sensor element 200 for detecting the weight- or acceleration-dependent compensation is arranged directly next to the first sensor element 180 in a second cavity 160, but separated therefrom by a partition wall. This partition wall does not necessarily have to fluidically separate the first cavity 140, in which the first capacitive measured value detection means or the reference capacitance is located, from the second cavity 260. The second sensor element 200 according to the illustration in FIG. 1 consists of a spring-mass system in the form of a rocker structure, in which a first (seismic) mass 230 and a second (seismic) mass 235 are connected to one another via a spring element 240 such that the masses 230 and 235 are designed to be movable upward 10 or downward 20, in particular perpendicular to the membrane 140, to the functional layer 135 or to the substrate 100. The suspension of the spring element 240 on a support within the second cavity 260 is not shown, but may be from corresponding constructions such as, for example, those in European Patent Nos. EP 0 244 581 B1 or EP 0 773 443 B1. The spring element 240 can be designed as a bending spring, a bending beam or also as a torsion spring. For reasons of symmetry, the two masses can also be arranged on their own spring element, in particular on a common central beam. Alternatively, the masses can also be connected to spring elements on two sides. Optionally, it can be provided that only the first mass 230 is attached to the spring element 240 and a second movable mass 235 is omitted, as shown in the exemplary embodiment of FIG. 2. The first mass 230 has an upper (movable) electrode 220 and a lower (rigid) electrode 225 located underneath it in order to realize a second capacitive measured value detection means within the scope of the compensation detection. In the present embodiment, the lower electrode 225 is also applied to the polysilicon layer 120. In addition, however, the lower electrode 225 can also be applied to the substrate 100 in another form and in particular be electrically insulated therefrom. In the exemplary embodiment shown in FIG. 1, the second mass 235 serves as an oscillation element which reacts to an existing acceleration or, in a rest position, to the acceleration due to gravity g. For this purpose, the second mass 235 is many times larger than the first mass 230, in particular by a factor of 2, 5 or 10. Because the second mass 235 is more massive, it reacts more pronouncedly to an acceleration perpendicular to the substrate 100 or to the membrane 140, so that the first mass 230, which is operatively connected to the second mass 235 via the spring element 240, is moved in the opposite or counter direction. Optionally, it can be provided that the first mass 230, the second mass 235 and the spring element 240 are also structured out of the functional layer 135.

In the resting phase of the pressure sensor, without any pressure of a medium applied to the membrane 140, the membrane 140 deflects downward 20 due to the total mass of the membrane 140 and the gel covering, which results in a reduction in the distance between the electrodes 150 and 155 and thus a change in capacitance. Because this deflection is not associated with any pressure change applied to the membrane 140, the aim of the construction of the second sensor element 200 according to the present invention is to detect a compensation of this weight-dependent or generally acceleration-dependent interference variable. Due to the asymmetrical construction of the rocker structure of FIG. 1, the second mass 235 is moved in the same direction as the membrane 140 by the acceleration due to gravity g or generally by an applied acceleration. Due to the rocker structure, a second sensor variable, which represents the interference variable, can be detected by moving the first mass 230 in the opposite direction. By means of a corresponding embodiment of the first and second masses or a suitably selected mass ratio, a second sensor variable can be generated which can be used directly as a compensation signal for the useful signal of the first sensor element 180. Alternatively, an additional compensation factor K can be used, with which the generated second sensor variable is multiplied in order to use the variable thus obtained as a compensation variable.

In the exemplary embodiment of FIG. 2, the first sensor element 180 and the second sensor element 200 are accommodated in a common cavity 175. This common cavity 175 exposes both sensor elements to the same direct environmental conditions. In addition, this construction makes the internal wiring and control of the sensor elements simpler and more direct. In addition, FIG. 2 shows a further construction of the spring-mass system for the second sensor element 200. In this case, only a first mass 230 is provided, which is attached via the spring element 240 to a suspension 250 directly on the cavity floor or the substrate 100. In this construction, therefore, only the first mass 230 is movable, wherein the first mass 230 moves in the same direction as the membrane 140 due to the acceleration due to gravity or another applied acceleration.

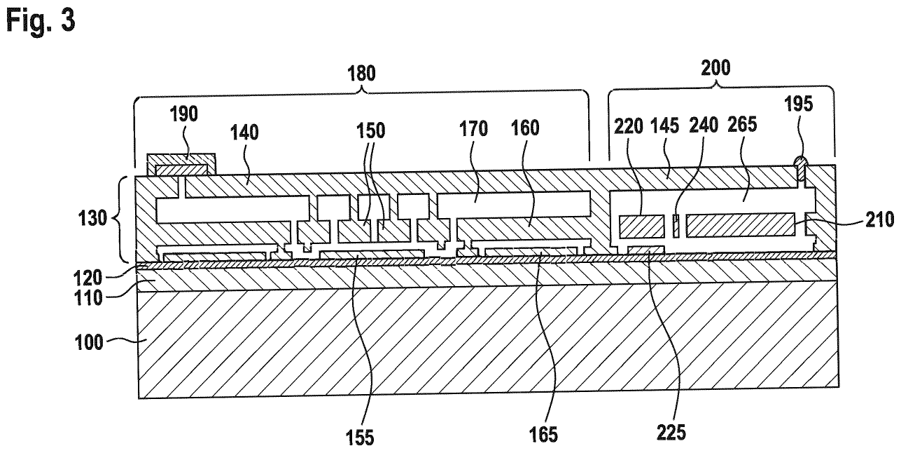

The exemplary embodiment of FIG. 3 explicitly describes a construction in which the first cavity 170 and the second cavity 265 are spatially and fluidically separated from each other. In order to prevent possible amplitude increases of the second sensor element 200 or the spring-mass system or the rocker structure when resonance vibrations occur, the second cavity 265 can be deliberately provided with a higher pressure than the first cavity. Example pressures are <5 kPa in the first cavity 170 and 10-100 kPa in the second cavity 265. For this purpose, separate openings can be introduced into the membrane 140 and the cover 145 of the second cavity 265 during the production process of the sensor arrangement, through which openings the pressure within the cavities can be individually set. After setting the internal pressure of the corresponding cavity, the membrane 140 can be closed with a first closure 190 and the cover 145 with a second closure 195. It is possible, for example, that during the common processing of the construction of the pressure sensor, the first closure 190 is initially closed, for example with a layer deposition process using oxide or nitride layers at a lower pressure. At a later time and at a higher ambient pressure, the second closure 195 can be closed by means of a laser reseal. Due to the higher pressure thus present in the second cavity 265, the second sensor element 200 is more strongly dampened, so that lower resonance vibrations can occur. In general, however, it is also possible to design the structure of the second sensor element 200 in such a way that its resonance frequency lies outside/above the application range of the pressure sensor.

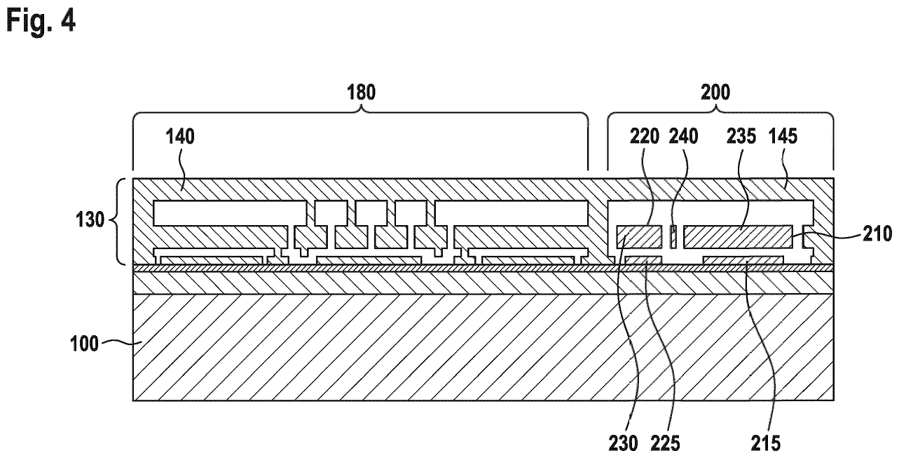

FIGS. 1 to 3 show exemplary embodiments in which the dimensions and thus the generation of the second sensor variable of the second sensor element 200 are determined by production. The exemplary embodiment of FIG. 4, on the other hand, shows a construction in which the oscillation properties of the spring-mass system or the rocker structure can be changed even after production. For this purpose, the second mass 235 has an electrode arrangement consisting of an upper (movable) electrode 210 and a lower (rigid) electrode 215, wherein the latter can also be arranged on the substrate 100 or a layer located thereon. These two electrodes 210 and 215 can be controlled in the form of a tuning electrode arrangement such that the movement behavior of the second mass 235 is changed or dampened up and down. By applying a direct current or a high-frequency pulsed voltage to the electrodes, the stiffness of the spring-mass system can be specifically adjusted via the value of the13ffecttive voltage. This effect is also called the electrostatic spring softening effect. Optionally, the second measured value recording, with the electrodes 220 and 225, can also be used as a tuning electrode arrangement.

When using a tuning electrode, for example, a method according to the flow chart of FIG. 6 can be used. First, in a first step 400, the effect of the acceleration due to gravity or another applied acceleration on the overall system consisting of the first and second sensor element is detected without applying a tuning voltage to the electrodes. Subsequently, in the following step 420, the capacitance change of the second sensor element 200 detected during this acceleration can be determined.

Based on the capacitance change thus detected, a corresponding voltage can be determined in the next step 440, at which the second sensor element 200 can be used, if necessary without a compensation factor K, to compensate for the first sensor variable. Such an adjustment can be carried out, for example, during production, so that the tuning voltage to be set can be determined in a targeted manner. The use of an acceleration stimulus which is sufficiently known, in particular the acceleration due to gravity, is suitable for this purpose.

The tuning electrodes can be operated at high frequency, wherein a first part of the clock cycle is used to provide an effective voltage and to cause the spring softening effect, wherein the capacitance is evaluated in a second part of the clock cycle. In this case, it is advantageous to connect the second sensor element to the reference sensor element in order to avoid possible negative influences of the electrical clocking on the membrane (for example, resonant excitation of membrane modes).

In a further embodiment, the electrode arrangement 210 and 215 can also be used as a third capacitive measured value detection means. For example, the detection of the second capacitive measured value detection means 220 and 225 can be supplemented, amplified or checked with a second value.

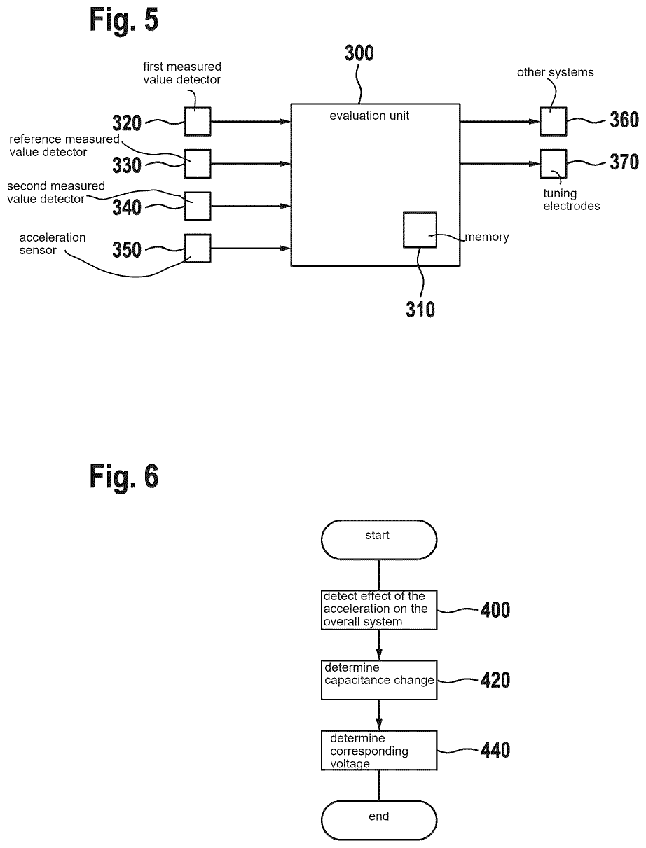

The first sensor element, consisting of the first measured value detection means 320 and at least one reference measured value detection means 330, as well as the second sensor element with the second measured value detection means 340 can be controlled, queried or connected in different ways. It is thus possible that an evaluation unit 300, as shown in the block diagram of FIG. 5, detects the sensor variables of the various detection means 320 to 340 separately and links them internally to one another in order to generate an acceleration-or weight-compensated sensor value or pressure sensor value. This compensated sensor value can then be forwarded to other systems 360 for further processing. In the event that the second sensor element has to be calibrated during production, the evaluation unit 300 can additionally detect a predetermined or determinable acceleration signal of a corresponding acceleration sensor 350 in order to determine therefrom a compensation factor K as a multiplier for the second sensor variable. This compensation factor K can be stored in a memory 310 and used for the further determination of the compensated sensor values. The comparison with the detected acceleration signal can also be used to control the tuning electrodes 370 accordingly in order to adjust the stiffness of the spring-mass system in a targeted manner.

The evaluation unit 300 can also be used to detect sensor variables of the interconnected first and second sensor elements. It can thus be provided that the first measured value detection means 320, the at least one reference measured value detection means 330 and the second measured value detection means 340 or also the third measured value detection means are at least partially directly electrically connected to one another in the structure of the micromechanical membrane sensor. For this purpose, wiring lines can be provided, for example, in the polysilicon layer 120, the oxide layer 110, the substrate 100 or another layer, so that the evaluation unit 300 can detect one or more of the detection units by means of a sensor variable.

In a first embodiment, the first measured value detection means 320, which, with the electrodes 150 and 155, represents a useful capacitance Cᵤₛₑ, and the second measured value detection means 340, which, with the electrodes 220 and 225, represents the compensation capacitance C_{comp}, are electrically connected in parallel in such a way that the evaluation unit can detect a common sensor variable. In addition, with the at least one separately detected reference measured value detection means 330, which, with the electrodes 160 and 165, represents the reference capacitance C_{ref}, the evaluation unit 300 determines the weight force- or acceleration-compensated sensor value of the sensor arrangement as a function of the capacitance change dC=(dCᵤₛₑ+dC_{comp})−dC_{ref}.

In a further embodiment, the second measured value detection means 340 directly compensates for the reference measured value detection means 330. In this case, the reference capacitance C_{ref} and the compensation capacitance C_{comp} are connected in parallel and the useful capacitance Cᵤₛₑ is detected separately. Thus, a weight force- or acceleration-compensated sensor value of the sensor arrangement can be determined depending on the capacitance change dC=dCᵤₛₑ−(dC_{ref}+dC_{comp}).

It is expressly noted that the features of the above embodiments and designs can be combined with one another.

1-12. (canceled)

13. A membrane sensor having a membrane, comprising
a first sensor element which detects a first sensor variable as a function of a movement of the membrane; and
a second sensor element which detects a second sensor variable as a function of a weight force;
wherein the second sensor element is configured such that the second sensor variable represents a weight force acting on the membrane.

14. The membrane sensor according to claim 13, wherein the membrane sensor is a pressure sensor.

15. The membrane sensor according to claim 13, wherein the second sensor element has a spring-mass system in which at least one first mass is connected to at least one spring element, wherein the first mass has a movable electrode of a second capacitive measured value detector.

16. The membrane sensor according to claim 15, wherein the second sensor element has a spring-mass system in the form of a rocker structure, wherein the spring-mass system has a second mass which is connected to a spring element, wherein the second mass has a movable electrode of an electrode arrangement of a third capacitive measured value detector.

17. The membrane sensor according to claim 16, wherein the second mass is larger than the first mass by a factor of 2 or 5 or 10.

18. The membrane sensor according to claim 16, wherein at least one of the electrodes of the electrode arrangement is controlled to change a stiffness of the spring-mass system.

19. The membrane sensor according to claim 15, wherein the spring element includes a bending spring or a torsion spring.

20. The membrane sensor according to claim 15, wherein the first sensor element generates a first useful signal as a function of the movement of the membrane using a first capacitive measured value detector and a reference signal independently of the movement of the membrane using at least one capacitive reference measured value detector.

21. The membrane sensor according to claim 20, wherein the measured value detector of the first sensor element and the second sensor element are electrically connected to one another, wherein the second capacitive measured value detection means is connected in parallel with the first capacitive measured value detector or with the capacitive reference value detector.

22. The membrane sensor according to claim 20, wherein the first sensor element is arranged in a first cavity and the second sensor element is arranged in a second cavity separated from the first cavity, and wherein the second cavity is filled with a medium which has a higher pressure than that present in the first cavity.

23. A method for determining a sensor value of a membrane sensor having a membrane, wherein the membrane sensor includes a first sensor element configured to detect a first sensor variable as a function of a movement of the membrane, and a second sensor element configured to detect a second sensor variable which represents a weight force acting on the membrane, the method comprising:
determining the sensor value as a function of the first sensor variable and the second sensor variable.

24. The method according to claim 23, wherein the second sensor element has a spring-mass system in the form of a rocker structure, wherein the spring-mass system includes:
a second mass which is connected to at least one spring element, and
a movable electrode of a capacitive electrode arrangement of a third capacitive measured value detector,
wherein the method further comprising controlling electrodes of the electrode arrangement to change a stiffness of the spring-mass system.

25. The method according to claim 23, wherein, to determine the sensor value, the second sensor variable is multiplied by a compensation factor.
